(19) United States
(12) Patent Application Publication
(10) Pub. No.: US 2022/0386823 A1
(43) Pub. Date: Dec. 8, 2022

(54) Chopping board with adjustable height

(71) Applicant: ZHUHAI DALI KITCHEN & BATHROOM TECHNOLOGY CO., LTD., Zhuhai (CN)

(72) Inventors: Jack Chen, Zhuhai (CN); Jiarong Li, Zhuhai (CN); Jimmy Nie, Zhuhai (CN)

(73) Assignee: ZHUHAI DALI KITCHEN & BATHROOM TECHNOLOGY CO., LTD., Zhuhai (CN)

(21) Appl. No.: 17/890,291

(22) Filed: Aug. 18, 2022

(30) Foreign Application Priority Data
Apr. 2, 2022 (CN) 202220782326.4

(51) Int. Cl. A47J 47/00

(52) U.S. Cl. CPC A47J 47/005

(57) ABSTRACT

The present disclosure discloses a chopping board with an adjustable height, including a sink, a support member, a countertop, and a chopping board main body; the sink is mounted at any position, i.e., above the countertop, in the countertop or below the countertop; an open pore is formed in the countertop; the chopping board main body is placed in the open pore; the support member is arranged at a bottom of the chopping board main body; and a height of the chopping board main body is adjusted through the support member. The present disclosure has the beneficial effects that the chopping board includes a removable part.

### TECHNICAL FIELD

The present disclosure relates to the field of household kitchen equipment, in particular to a chopping board with an adjustable height.

### BACKGROUND

In the current market, when a user chooses a sink, a chopping board main body matched with the chosen sink can only be used with a countertop with a fixed size and thickness and cannot be used for coutertops with different thicknesses, so that there will be a phenomenon that a chopping board main body does not match a countertop, resulting in a problem that the chopping board main body is higher or lower than the countertop. As a result, the appearance is affected, and the chopping board main body is inconvenient to use. The entire sink needs to be replaced if adjustment is required, leading to high cost.

### SUMMARY

The present disclosure provides a chopping board with an adjustable height, including a removable part. An effect that the chopping board is normally used after being assembled and hardly falls off can be achieved by controlling an assembling clearance between the support member and a chopping board main body; the overall appearance is consistent; the assembling is beautiful and natural; and the height of the chopping board main body can be self-adjusted to meet the needs in various cases.

In order to achieve the above disclosure objective, the present disclosure provides the following technical solution:

A chopping board with an adjustable height includes a sink, a support member, a countertop, and a chopping board main body; the sink is mounted at any position, i.e., above the countertop, in the countertop or below the countertop; an open pore is formed in the countertop; the chopping board main body is placed in the open pore; the support member is arranged at a bottom of the chopping board main body; and the support member adjusts a height of the chopping board main body.

Preferably, the support member includes a wedge and a support frame. The support frame and the chopping board main body are connected through the wedge, which can ensures that the chopping board main body is aligned with the countertop in height to improve the beauty and practicability.

Preferably, the support member is a plug. The height of the chopping board main body is controlled through the plug, which can ensure that the chopping board main body is aligned with the countertop in height to improve the beauty and practicability.

Preferably, the support member is a foot pad. The height of the chopping board main body is controlled through the foot pad, which can ensure that the chopping board main body is aligned with the countertop in height to improve the beauty and practicability.

Preferably, the support member and the chopping board main body is connected in a joggled or threaded or adhered manner, which can ensure that the chopping board main body is aligned with the countertop in height to improve the beauty and practicability.

Compared with the prior art, the present disclosure has the beneficial effects:

The purpose of adjusting the height of the chopping board main body is achieved by replacing different support members, specifically including a wedge and a support frame; a plug; and a foot pad. During replacement of the countertop, it is not necessary to replace the entire sink, but only the support member is replaced, which ensures that the chopping board main body can be aligned with a new countertop to make a kitchen more beautiful and to facilitate users. Secondly, the sink can be assembled below the open pore of the countertop, and the chopping board main body covers the sink to hide the sink. The sink can be used after the chopping board main body is moved away. The chopping board main body is moved back to cover the sink when the sink is not used. Therefore, the space in the kitchen is saved. If the sink is assembled above the countertop, it can still ensure by means of replacing the support member that the chopping board can still be aligned with the countertop after the sink is moved, and the cost is reduced.

### BRIEF DESCRIPTION OF THE DRAWINGS

FIG. 1 is a schematic diagram of a split structure of Embodiment I of the present disclosure;

FIG. 2 is a schematic diagram of a split structure of Embodiment II of the present disclosure;

FIG. 3 is a schematic diagram of a split structure of Embodiment III of the present disclosure;

FIG. 4 is a schematic diagram of a split structure of Embodiment IV of the present disclosure;

FIG. 5 is a schematic diagram of an overall structure of Embodiment I of the present disclosure, wherein a circle part in this figure is a partially structural diagram magnified by three times;

FIG. 6 is a schematic diagram of an overall structure of Embodiment II of the present disclosure, wherein a circle part in this figure is a partially structural diagram magnified by three times;

FIG. 7 is a schematic diagram of an overall structure of Embodiment III of the present disclosure, wherein a circle part in this figure is a partially structural diagram magnified by three times;

FIG. 8 is a schematic diagram of an overall structure of Embodiment IV of the present disclosure, wherein a circle part in this figure is a partially structural diagram magnified by three times.

### DETAILED DESCRIPTION OF THE EMBODIMENTS

The technical solutions in the embodiments of the present disclosure will be described clearly and completely below with reference to the drawings in the embodiments of the present disclosure. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

It should be noted that all directional indications (such as up, down, left, right, front, back...) in the embodiments of the present disclosure are only used to explain a relative positional relationship between components, motion situations, etc. at a certain specific attitude (as shown in the figures). If the specific attitude changes, the directional indication also correspondingly changes.

In addition, the descriptions of “first”, “second”, etc. in the present disclosure are only used for descriptive purposes, and cannot be understood as indicating or implying its relative importance or implicitly indicating the number of technical features indicated. Thus, the features defined with “first” and “second” may expressly or implicitly include at least one of the features; secondly, in the description of the present disclosure, “plurality” means at least two, for example two, three, etc., unless expressly specifically limited otherwise.

In the present disclosure, unless otherwise expressly specified and defined, terms “connection”, “fixing” and the like are broadly understood. For example, “fixing” may be fixed connection, detachable connection, integration, mechanical connection, electrical connection, direct connection, indirect connection by using an intermediate medium, interior connection between two elements, or interaction between two elements. Unless otherwise expressly defined, a person of ordinary skill in the art may understand specific meanings of the foregoing terms in the present disclosure according to a specific situation.

In addition, the technical solutions between the various embodiments of the present disclosure can be combined with each other, but it must be based on what can be achieved by those of ordinary skill in the art. When the combination of technical solutions is contradictory or cannot be achieved, it should be considered that such a combination of technical solutions does not exist, and is not within the scope of protection claimed by the present disclosure.

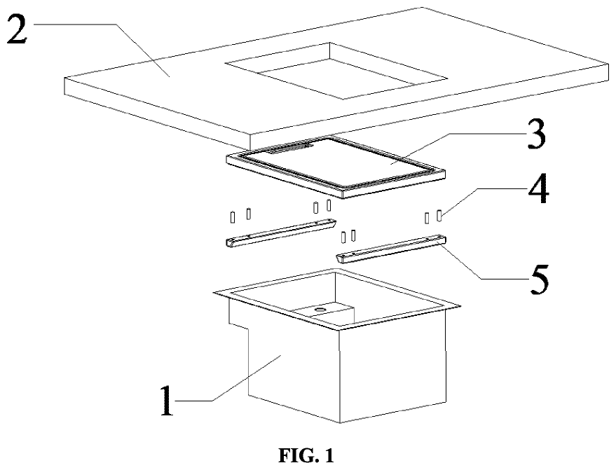

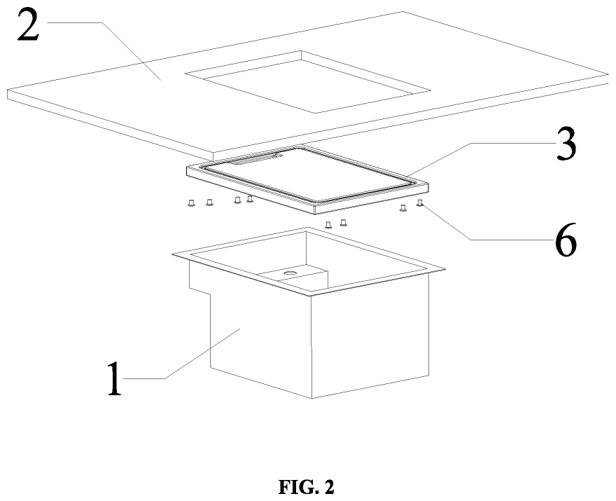

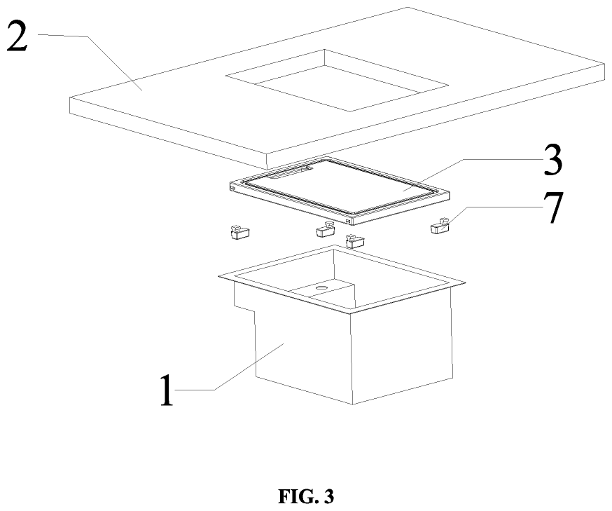

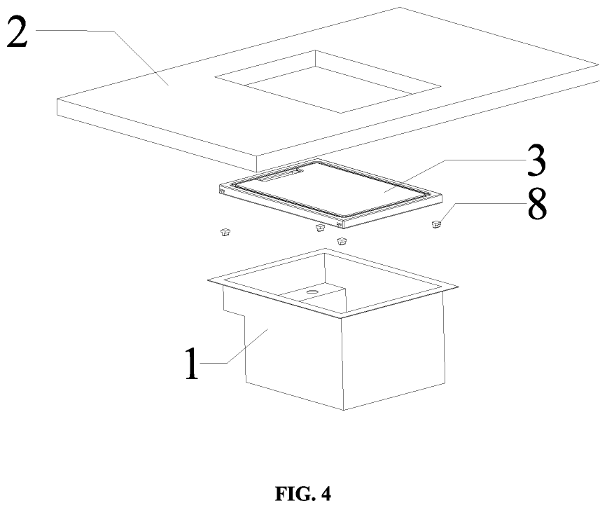

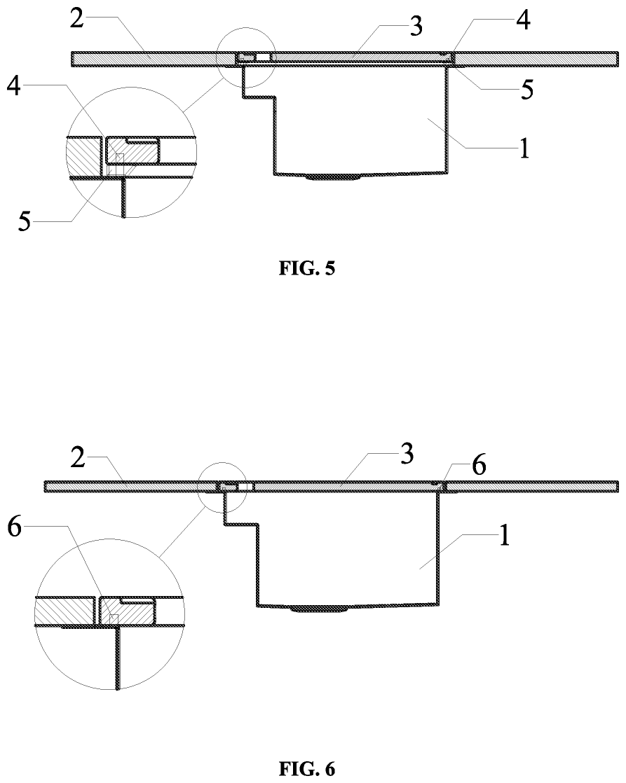

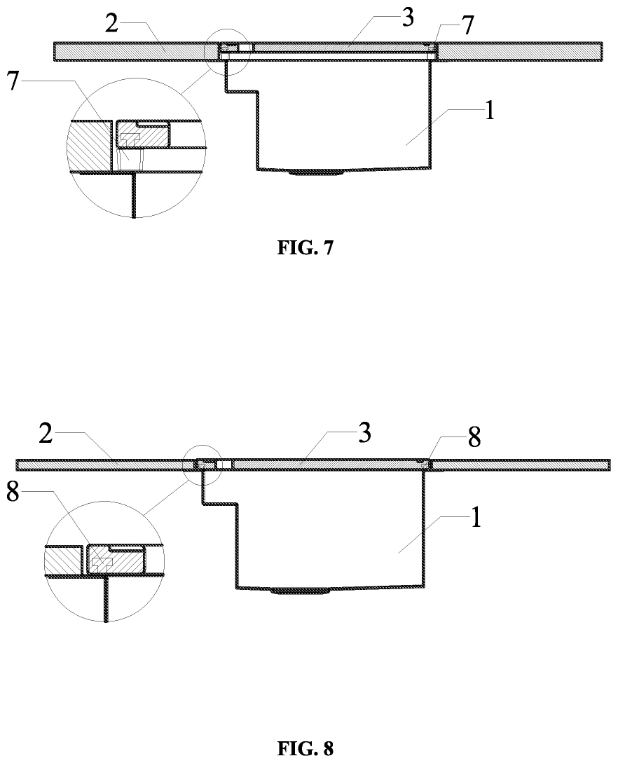

Referring to FIG. 1-FIG. 8, FIG. 1 is a schematic diagram of a split structure of Embodiment I of the present disclosure; FIG. 2 is a schematic diagram of a split structure of Embodiment II of the present disclosure; FIG. 3 is a schematic diagram of a split structure of Embodiment III of the present disclosure; FIG. 4 is a schematic diagram of a split structure of Embodiment IV of the present disclosure; FIG. 5 is a schematic diagram of an overall structure of Embodiment I of the present disclosure, wherein a circle part in this figure is a partially structural diagram magnified by three times; FIG. 6 is a schematic diagram of an overall structure of Embodiment II of the present disclosure, wherein a circle part in this figure is a partially structural diagram magnified by three times; FIG. 7 is a schematic diagram of an overall structure of Embodiment III of the present disclosure, wherein a circle part in this figure is a partially structural diagram magnified by three times; and FIG. 8 is a schematic diagram of an overall structure of Embodiment IV of the present disclosure, wherein a circle part in this figure is a partially structural diagram magnified by three times.

An embodiment of the present disclosure provides a chopping board with an adjustable height. Names of components corresponding to all reference numerals in the drawings are as follows: sink 1, countertop 2, chopping board main body 3, wedge 4, support frame 5, plug 6, foot pad 7, and foot pad 8.

A chopping board with an adjustable height includes a sink 1, a support member, a countertop 2, and a chopping board main body 3; the sink 1 is mounted at any position, i.e., above the countertop 2, in the countertop 2 or below the countertop 2; an open pore is formed in the countertop 2; the chopping board main body 3 is placed in the open pore; the support member is arranged at a bottom of the chopping board main body 3; and the support member adjusts a height of the chopping board main body 3.

### Embodiment I

As shown in FIG. 1 and FIG. 5, a sink 1 is mounted below a countertop 2, and an open pore is formed in the countertop 2; a chopping board main body 3 is placed in the open pore; support members are arranged at a bottom of the chopping board main body 3; wedges 4 and support frames 5 are used as the support members; and the wedges 4 are connected to the support frames 5 and the chopping board main body 3 in a joggled, threaded or adhered manner to control the height of the chopping board main body 3.

### Embodiment II

As shown in FIG. 2 and FIG. 6, a sink 1 is mounted below a countertop 2, and an open pore is formed in the countertop 2; a chopping board main body 3 is placed in the open pore; support members are arranged at a bottom of the chopping board main body 3; plugs 6 are used as the support members; and the plugs 6 are connected to the chopping board main body 3 in a joggled, threaded or adhered manner to control the height of the chopping board main body 3.

### Embodiment III

As shown in FIG. 3 and FIG. 7, a sink 1 is mounted below a countertop 2, and an open pore is formed in the countertop 2; a chopping board main body 3 is placed in the open pore; support members are arranged at a bottom of the chopping board main body 3; foot pads 7 are used as the support members; and the foot pads 7 are connected to the chopping board main body 3 in a joggled, threaded or adhered manner to control the height of the chopping board main body 3.

### Embodiment IV

As shown in FIG. 4 and FIG. 8, a sink 1 is mounted below a countertop 2, and an open pore is formed in the countertop 2; a chopping board main body 3 is placed in the open pore; support members are arranged at a bottom of the chopping board main body 3; foot pads 8 are used as the support members; and the foot pads 8 are connected to the chopping board main body 3 in a joggled, threaded or adhered manner to control the height of the chopping board main body 3.

Compared with the prior art, the present disclosure has the beneficial effects:

The purpose of controlling an assembling clearance from the chopping board main body 3 is achieved by replacing different support members, specifically including wedges 4 and support frames 5; plugs 6; and foot pads 7 and foot pads 8. During replacement of the countertop 2, it is not necessary to replace the entire sink 1, but only the support members are replaced, which ensures that the chopping board main body 3 can be aligned with a new countertop 2 and will not be higher than or lower than the countertop, so as to make a kitchen more beautiful and to facilitate users. Secondly, the sink 1 can be assembled below the open pore of the countertop 2, and the chopping board main body 3 covers the sink 1 to hide the sink 1. The sink 1 can be used after the chopping board main body 3 is moved away. The chopping board main body 3 is moved back to cover the sink when the sink is not used. Therefore, the space in the kitchen is saved. If the sink 1 is assembled above the countertop 2, it can still ensure by means of replacing the support members that the chopping board main body 3 can still be aligned with the countertop 2 after the sink 1 is moved, and the cost is reduced.

Therefore, the present disclosure provides a chopping board with an adjustable height, including a removable part. An effect that the chopping board is normally used after being assembled and hardly falls off can be achieved by controlling an assembling clearance between the support members and the chopping board main body; the overall appearance is consistent; the assembling is beautiful and natural; and a function of hiding the sink can also be realized in a full-coverage mode of the chopping board main body, which saves the space.

The above descriptions are only the preferred embodiments of the present disclosure. It should be noted that the above preferred implementations should not be regarded as limitations to the present disclosure, and the protection scope of the present disclosure should be based on the scope defined by the claims. Those of ordinary skill in the art can also make several improvements and retouches without departing from the spirit and scope of the present disclosure, and these improvements and retouches shall also fall within the protection scope of the present disclosure.

What is claimed is:

1. A chopping board with an adjustable height, comprising a sink, a support member, a countertop, and a chopping board main body, wherein the sink is mounted at any position, i.e., on the countertop, in the countertop or below the countertop; an open pore is formed in the countertop; the chopping board main body is placed in the open pore; the support member is arranged at a bottom of the chopping board main body; and the support member adjusts a height of the chopping board main body.

2. The chopping board with the adjustable height according to claim 1, wherein the support member comprises a wedge and a support frame.

3. The chopping board with the adjustable height according to claim 1, wherein the support member is a plug.

4. The chopping board with the adjustable height according to claim 1, wherein the support member is a foot pad.

5. The chopping board with the adjustable height according to claim 1, wherein the support member and the chopping board main body is connected in a joggled or threaded or adhered manner.
